(19) United States
(12) Patent Application Publication
(10) Pub. No.: US 2016/0006679 A1
(43) Pub. Date: Jan. 7, 2016

(54) SYSTEM AND METHOD FOR RECOMMENDING MULTIMEDIA FOR PLAIN-TEXT MESSAGES

(71) Applicant: KITRI SOFTWARE LLC, Wilmington, DE (US)

(72) Inventors: Philip WILLIAMS, Wilmington, DE (US); Benjamin SMITH, Sudbury, MA (US)

(21) Appl. No.: 14/793,238

(22) Filed: Jul. 7, 2015

Related U.S. Application Data
(60) Provisional application No. 62/021,443, filed on Jul. 7, 2014.

(51) Int. Cl. H04L 12/58; G06F 17/30; H04W 4/14

(52) U.S. Cl. CPC H04L 51/10; H04W 4/14; G06F 17/30029

(57) ABSTRACT

Systems, methods, and computer program products for recommending multimedia content for inclusion in a message for transmission from a first computing device to a second computing device, is disclosed. A server may receive a plain text message from the first computing device. The server may then parse the plain text message to create a parsed plain text message comprising one or more words and characters. The server may then query a multimedia content database for multimedia content matching a portion of the parsed plain text message. The matched portion, or portions, of the multimedia content are then presented as recommendations on a user interface of the first computing device, to a user of the first computing device, for inclusion as part of a message for transmission to the second computing device.

### CROSS-REFERENCE TO RELATED APPLICATION

This application claims the benefit under 35 U.S.C. §119(e) of U.S. Provisional Application No. 62/021,443, filed Jul. 7, 2014, the entire disclosure of which is incorporated herein by reference.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Capabilities of computing devices has increased in recent years. For example, among other improvements, higher data transfer rates and increased data storage space have allowed for larger amounts of multimedia content to be transmitted, or messaged, between computing devices. However, the process of identifying and capturing multimedia content in a form suitable for transmission between messaging clients of computing devices is tedious and not user friendly.

Currently, messaging systems allow users to send messages in various media forms such as text, image, video, voice message, or current location. However, the ability to search a global database and return recommendations to enhance aspects of a message (otherwise sent as simply plain text) with a multimedia alternative are non-existent.

Accordingly, it is desirable to provide a system for searching, recommending, and inserting pre-formatted variable length multimedia content into a message for transmission between computing devices.

### BRIEF DESCRIPTION OF THE INVENTION

Systems, methods, and computer program products for recommending multimedia content for inclusion in a message for transmission, from a first computing device to a second computing device, are disclosed. A server may receive a plain text message from the first computing device. The server may then parse the plain text message to create a parsed plain text message comprising one or more words and characters. The server may then query a multimedia content database for multimedia content matching a portion of the parsed plain text message. The matched portion, or portions, of the multimedia content may be presented as recommendations on a user interface of the first computing device for inclusion as part of a message for transmission to the second computing device.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is an overview of a system according to an embodiment of the present invention;

FIG. 2A is an example of a user interface, on a computing device, allowing user to enter a plain text message according to an embodiment of the present invention;

FIG. 2B is an example of a user interface, on a computing device, displaying results of a multimedia content search according to an embodiment of the present invention;

FIG. 3A is an example of a user interface, on a computing device, displaying lyrics of a song matching the plain text message according to an embodiment of the present invention;

FIG. 3B is an example of a user interface, on a computing device, displaying highlighted lyrics of a song that match the plain text message according to an embodiment of the present invention;

FIG. 4 is an example of a user interface, on a computing device, displaying received multimedia content in a message bubble, according to an embodiment of the present invention;

FIG. 5A is an example of a user interface, on a computing device, displaying frames of video content matching the plain text message according to an embodiment of the present invention; and

FIG. 5B is an example of a user interface, on a computing device, displaying highlighted frames of video content that match the plain text message according to an embodiment of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

This patent application includes an Appendix having a file named Appendix688815-1US.txt, created on Jul. 7, 2014, and having a size of 9856 bytes. The Appendix is incorporated by reference into the present patent application. One preferred embodiment of the present invention is implemented via the source code in the Appendix. The Appendix is subject to the “Copyright Notice and Authorization” stated above.

Increased capabilities of computing devices allow users to convey messages to other computing devices in different media forms. For example, messages which, in the past may have been conveyed in a mere plain text format, may now be supplemented or enhanced with other, more dynamic formats, such as audio, images, video, and the like. However, identifying relevant multimedia content to convey a message, that formerly may have been conveyed simply by a plain text message, can be a difficult task. For example, when a user wishes to share multimedia content with a recipient, she may first need to leave the messaging program, search, such as from a web browser or locally on the device itself, for desired multimedia content related to the message she would like to convey to the recipient, copy a link to any identified relevant multimedia content, paste the link back into the messaging program, and finally send the message to the recipient.

Disclosed embodiments of the present invention provide a solution to such difficulties by searching, recommending, and allowing for the insertion of pre-formatted variable length multimedia content relevant to a plain text message for transmission to another computing device. For example, a user may wish send a text message to a friend stating “Happy Birthday Friend.” However, instead of just a mere plain text message, she may want to enhance the message by also sending multimedia content, such as, for example, a clip of a song singing Happy Birthday. According to an embodiment of the present invention, an application may search, via a database of multimedia content on the internet, or multimedia content stored locally on the user's computing device, for songs containing lyrics that match one or more words of the plain text message “Happy Birthday Friend.” The tool will present to the user songs, as well, as the specific portions of songs corresponding to the matched words of the plain text. The tool allows the user to then select the matched portion in the form of a song clip having timestamps corresponding to the matched lyrics. The song clip can then be inserted into the text message for transmission to the recipient.

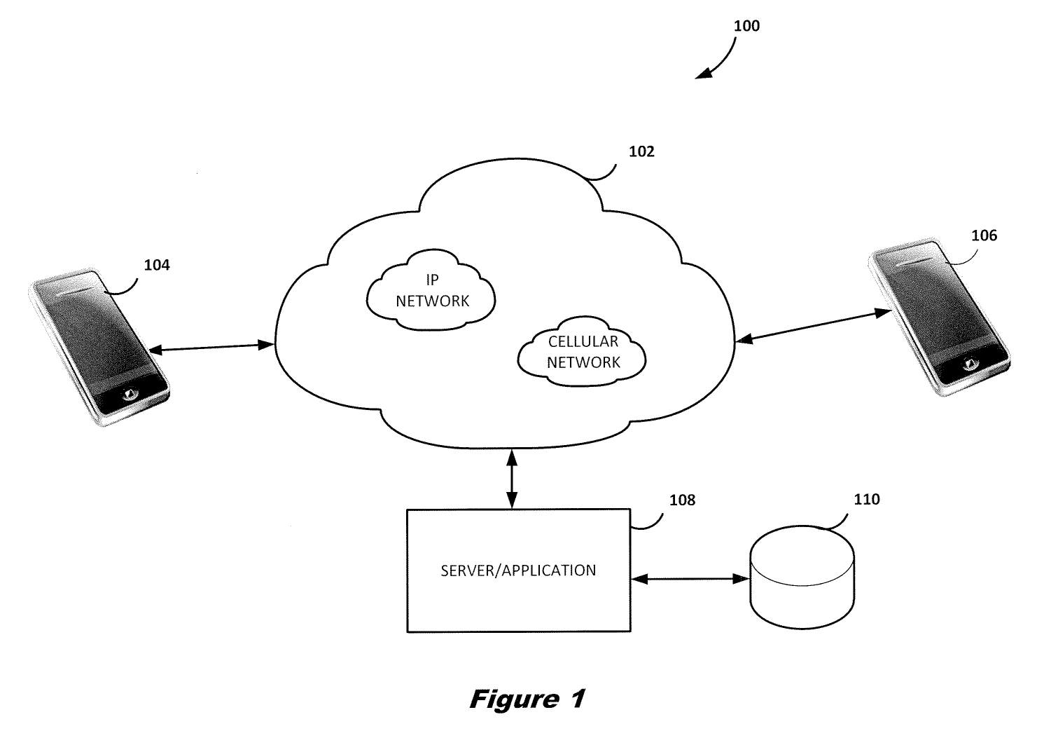

Referring to FIG. 1, according to embodiments of the present invention, a system 100 includes a communication network 102 which operatively couples various computing devices, such as computing devices 104 and 106, a server 108, and multimedia content database 110. The communication network 102 may include any suitable circuitry, device, system, or combination of these (e.g., a wireless or hardline communications infrastructure including towers and communications servers, an IP network, and the like) operative to create the communications network 102. The communication network 102 can provide for communications in accordance with any wired or wireless communication standard. For example, the communication network 102 can provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, the communication network 102 may be configured to provide for communications in accordance with techniques such as, for example, radio frequency (RF), infrared, or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth™, ultra wideband (UWB) and/or the like.

Computing devices 104 and 106 may refer to, without limitation, one or more personal computers, laptop computers, personal media devices, display devices, video gaming systems, gaming consoles, cameras, video cameras, MP3 players, mobile devices, wearable devices, wearable devices (e.g., iWatch by Apple, Inc.), mobile telephones, cellular telephones, GPS navigation devices, smartphones, tablet computers, portable video players, satellite media players, satellite telephones, wireless communications devices, or personal digital assistants (PDA).

Generally, according to an embodiment of the present invention, one of the computing devices 104, makes a request to the server 108 for recommendations for multimedia content that could be used in place of, or in addition to, user entered plain text in an email, text message, or other form of messaging. The server 108, or application run locally on the computing device itself, parses the entered plain-text message content, queries the multimedia content database 110, and identifies multimedia content matching (e.g., that the server/application deems most relevant) at least a portion (e.g., keyword(s), whole phrases, and the like) of the parsed plain text. The matched media content is then recommended to the user via a user interface of the mobile device 104. The multimedia content search may employ any search algorithm as known in the art. Such a search may match multimedia content using metadata associated the multimedia content. The type of metadata used to perform the query depends on the desired type of multimedia content. For example, if the multimedia content takes the form of audio, such as, for example, a song, the metadata may include lyrics and associated timestamps, artists, song title, or genre. If the multimedia content takes the form of video, the metadata may include dialogue or script. It should be noted that the multimedia content is not limited to audio and video. The multimedia content and associated metadata in the database 110 may include, but is not limited to: emoticons, social media posts, business advertisements associated with a user's current location (e.g., coupons, sales, and the like), phone contacts and/or addresses, tagged photos, and the like. The user of computing device 104 may select the recommended content (e.g., the matched multimedia content) for transmission to another computing device 106 of the recipient.

In the description hereinthroughout, the term “app” or “application” or “mobile app” may refer to, for example, an executable binary that is installed and runs on a computing device, or a web site that the user navigates to within a web browser on the computing device, or a combination of them. An “app” may also refer to multiple executable binaries that work in conjunction on a computing device to perform one or more functions.

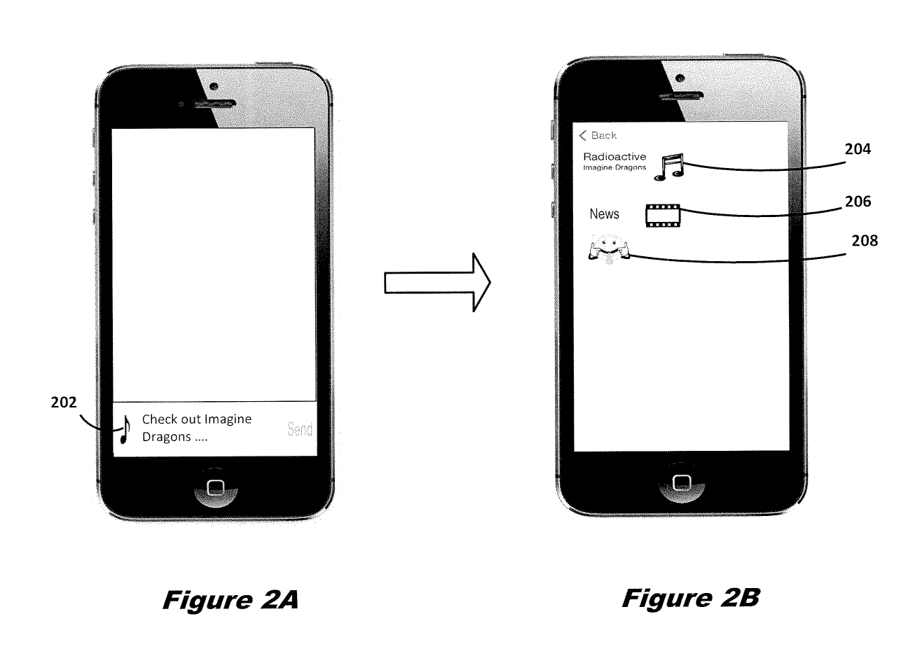

FIGS. 2A-2B illustrate, in more detail, the recommendation and insertion techniques of multimedia content for transmission in a message to a recipient, according to an embodiment of the present invention. As shown in FIG. 2A, a text messaging interface 200 presented on a computing device (such as, for example, computing device 104 of FIG. 1) allows a user to enter a plain-text message for eventual transmission to a recipient via his or her computing device (such as, for example, computing device 106 of FIG. 1). Instead of simply conveying the message in a plain text format, the user may wish to express him or herself in a more dynamic manner. That is, the user may wish to use multimedia content to convey his or her message to a recipient instead of mere plain text. More specifically, the user may wish to supplement, or replace the plain text message with multimedia content related to the content of the plain text message.

Upon entering the plain text (such, for example, text about a musical artist, song, or the like), the user may press a search button 202 shown in FIG. 2A as a musical note (however any symbol or button may be used). Upon pressing the search button 202, the computing device 104 sends the plain text message to the server (such as the server 108 shown in FIG. 1), where the plain text message is parsed for one or more key terms, and run through a standard search algorithm to display a list of relevant multimedia matches from multimedia database 110. As discussed above with respect to FIG. 1, instead of sending the message to the server 108, an application according to embodiments may be run locally on the computing device 104 to perform the search and recommendation for locally stored multimedia content. Such a search algorithm may find content based upon individual words and/or phrases included in the user's plain-text message, and matches the content with metadata of multimedia content located in the multimedia database 110.

During, or upon completion of the search, the server 108 (or application locally) returns a list of any matched content. An example screenshot of such a list is shown in FIG. 2B. The list includes several selections of multimedia content matching metadata of the entered plain text. Such selections include, for example, audio content (e.g., a song) 204, a video clip 206, and emoticon 208.

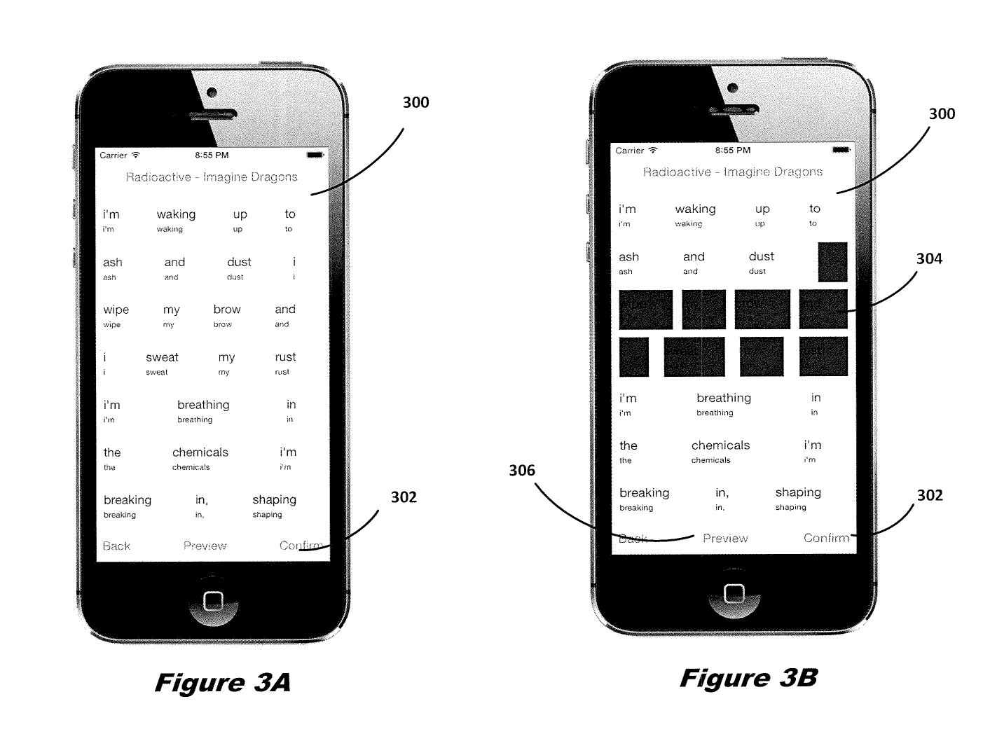

Upon selection of the matched multimedia content, the application allows the user to select a specific portion of the multimedia content for insertion in the message. FIGS. 3A and 3B are example screenshots of an interface on the computing device 104 presented to the user in the instance the user selects the song 204.

Continuing with the foregoing example, FIGS. 3A and 3B depict a user interface 300 presenting the user with a lyric file of the selected song 204, displaying each word of the lyrics. As shown in FIG. 3B, a specific portion 304 (e.g., string of words from the lyrics) from the song matching the plain-text entered by the user, is highlighted, or otherwise denoted as matched content. Upon confirming (such as by selecting the confirm button 302) that the highlighted portion is the section of the song he or she wishes to send to the recipient, the time stamps associated with the highlighted lyrics are transmitted to the server 108 (or locally via the discussed application) where a copy of the selected portion of the music file, is created. The user is then returned to a main messaging screen from which the user may send the message containing the enhanced message including the multimedia content. Prior to confirmation, the user may also preview the song clip (via pressing a preview button 306).

Once sent, the multimedia content that is provided as a song clip, video, image file, or the like is processed according to the application in real time. Depending on the recipient's preselected preferences, the user will either receive the message as a full copy of the multimedia content, or some indicator associated with the plain text (e.g., an icon or different color message bubble), indicating to the user that there may be multimedia content to download.

Sensitive to transfer rates and computing device capacities, embodiments allow the recipient to allocate the certain amount of storage space to the application, and whether any received multimedia content will be transferred only over Wi-Fi or cellular networks, potentially depending on the existing storage space of the computing device of the recipient.

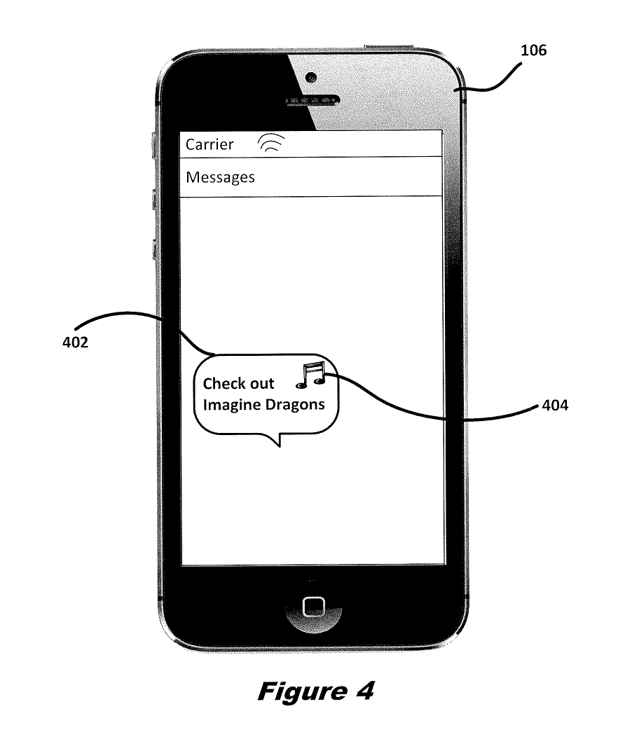

Referring now to FIG. 4, the recipient receives the message containing the multimedia content in a message bubble 402 of a messaging program. As shown, the plain text may have some indicator 404 to indicate to the user that there is multimedia content associated with the plain text message. The recipient then has the option of selecting the indicator 404, (for example, to download the multimedia content), in the message bubble 402 to hear the song clip.

It should be noted that the message bubble 402 shown in FIG. 4 is by way of non-limiting example only. The message bubble 402 may take a different form or different color depending on the type of multimedia content received. Such message bubble distinctions may help the recipient quickly ascertain the type of multimedia content he or she has received. For example, a message that relates to audio content may appear in blue. Alternatively, a message that relates to video content may appear in yellow message bubble, while a copy of a friend's media post may appear in a green message bubble. In light of the disclosure herein, one skilled in the art will appreciate that the message bubbles may have custom actions associated with them. For example, clicking on a bubble that contains the text for a song clip will play that song clip on the recipient's device. Moreover, clicking on a bubble that contains an emoticon will animate the emoticon.

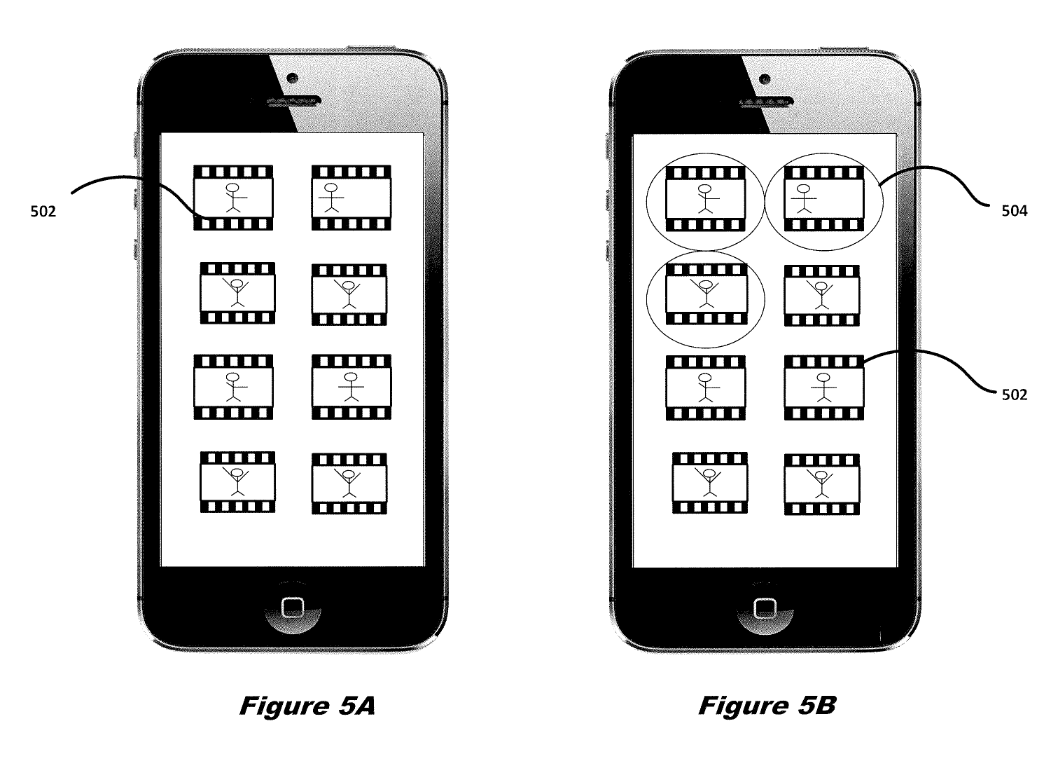

As mentioned above, embodiments of the present invention are not limited to the recommendation and insertion of audio content. For example, another embodiment of the present invention is directed to the recommendation and insertion of video content associated with plain text in a message. Referring back to the list of matched multimedia content in FIG. 2B, instead of selecting audio content 204 associated with the plain text message, a user may select video content 206 associated with the plain text message. As shown as an example in FIG. 2B, the user may select matched video content 206 from a news source (e.g., 6 pm News). Upon selection of this title, the user is presented with a series of individual frame shots 502 at various intervals (e.g., frame at 1 second, 3 seconds, and the like), an example screen of which is illustrated in FIG. 5A. The specific frames corresponding to dialogue or script matching at least a portion of the plain text message may already be highlighted or otherwise distinguished from other frames. For example, as shown in FIG. 5B, the recommended frames 504 are encircled.

Upon confirmation from the user, the time stamps from the recommended frames 504 are sent to the server 108, which generates a URL for the recipient to download a copy of the video file containing the selecting frames. Upon receiving the message, the recipient can press on the message bubble (in a similar manner as described above in connection with FIG. 4) to play the video clip. Even though embodiments recommend specific matched sections, it should be noted that the user may select any portion or portions of the multimedia content for inclusion in the message to the recipient.

As discussed above, it has also become common to transmit so-called emotional icons, otherwise known as emoticons, within messages. Such emoticons typically consist of one or more keyboard characters which can be understood to convey voice inflections, facial expressions, gestures, etc. For example, the ubiquitous “smiley face,”:-) is often transmitted to express happiness. As is well understood, this emoticon is constructed from a colon character, a dash character and a close parentheses character. There are a good number of such emoticons that can be constructed from ordinary keyboard characters. Such text emoticons are now, oftentimes translated into respective graphical representations. For example, the ubiquitous :) is often depicted by software programs as an upright face with two eyes and a smiling mouth (a smiley face).

Embodiments of the present invention may be also be applicable to these graphic emoticons or other images as well. More specifically, instead of keywords matching song lyrics from audio content or dialogue/script from video content, embodiments may match a list of metadata tags for emoticons or images. For example, a user may wish to include an emoticon in a message to a recipient, (such as, for example, selecting any matched emoticon 208 in the interface illustrated in FIG. 2B). For example, the user may wish to send a message to a friend saying “I'm happy!”. The server (or local application) may parse the plain text message, and search for emoticons having metadata matching the parsed plain text message. In this case, the server/application may return various happy-faced emoticons from which a user can select.

Upon selection of the matched emoticon 208, the user may be provided with an interface showing various illustrations of the message containing the inclusion of the emoticon or image. For example, the interface may display the emoticon or image which can be used in place of a word or phrase, or overlaid on the message view. The user can select from the various recommended illustrations. Upon confirmation of the message (e.g., in a similar manner to the above embodiments), the selected illustration may be included in a message for transmission to a recipient.

The user may further customize the message by applying animation to the emoticon. For example, after selecting a recommended emoticon, with a cursor (e.g., a drawing wand on the interface), the user may draw, i.e., trace, a pattern on the screen that the emoticon will follow upon activation by the recipient pressing the message bubble containing the message. By way of non-limiting example only, the user may move the wand in an upwards and downwards fashion, which may cause the emoticon to appear to bounce within the screen of a recipient's computing device upon activation. As another example, the user may move the wand in a zig-zag pattern across the screen. Consequently, upon activation by the recipient, the emoticon may similarly appear to zig-zag across the screen. Instead of creating his or her own pattern for the emoticon to follow, embodiments also allow the user to choose a predefined pattern or animation from a set of default animations. The emoticon's animation can occur within the bounds of the message bubble or outside the bubble in response to the animated being activated (i.e., when the message bubble is pressed).

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a computing device. In the alternative, the processor and the storage medium may reside as discrete components in a computing device.

In one or more exemplary designs, the functions described may be implemented in hardware, software, firmware, or any combination thereof. If implemented in software, the functions may be stored on or transmitted over as one or more instructions or code on a computer-readable medium, and preferably on a non-transitory computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In light of the foregoing, disclosed embodiments of the present invention employ a carefully indexed database of time-stamped lyrical representations of songs, frame-divided video files, and categorized tagged photos and emoticons. An existing messaging application will provide search results with content that has already been pre-formatted to modify or send along with an existing plain-text message. Embodiments of the present invention are applicable with any messaging program including electronic mail programs.

Also in light of the foregoing, embodiments of the present invention allow a user to more quickly create ring tones or small clips of a video file by searching against a plain text message. For example, according to embodiments, the user has the ability to crop music from lyrics or video from individual frames. Once a user purchases a song from an existing electronic music store, he could create his own ringtone or smaller video clip from the multimedia content. As such, the value of any purchased content may be enhanced.

One preferred embodiment of the present invention is implemented via the source code snippets in the accompanying Appendix. However, the scope of the present invention is not limited to this particular implementation of the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A method for recommending multimedia content for inclusion in a message for transmission from a first computing device to a second computing device, the method comprising:
receiving a plain text message from the first computing device;
parsing the plain text message to create a parsed plain text message;
querying a multimedia content database for multimedia content matching a portion of the parsed plain text message; and
providing, as a recommendation, on a user interface of the first computing device, the matched multimedia content for inclusion as part of a message for transmission to the second computing device.
